(19) United States
(12) Patent Application Publication
(10) Pub. No.: US 2001/0003541 A1
(43) Pub. Date: Jun. 14, 2001

(54) Speaker system

(76) Inventors: Shinji Koyano, Saitama (JP); Teruo Baba, Saitama (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/732,705

(22) Filed: Dec. 11, 2000

(30) Foreign Application Priority Data
Dec. 10, 1999 (JP) 11-351457

(51) Int. Cl. H04R 3/00; H04R 29/00; H04R 1/00; H04R 9/06; H04R 11/02

(52) U.S. Cl. 381/111; 381/58; 381/59; 381/398

(57) ABSTRACT

A speaker system includes a speaker, a detector for detecting an amplitude value of a diaphragm of the speaker to produce an amplitude signal corresponding to the amplitude value, and an adder for adding the amplitude signal to a driving signal for driving the speaker. In this configuration, the bass range characteristic of the speaker can be improved.

### BACKGROUND OF THE INVENTION

1. Field of the Invention

This invention relates to a speaker system with an improved bass range characteristic.

2. Description of the Related Art

In recent years, miniaturization of audio appliances, particularly, that of a speaker in a manner mounted in a personal computer has been developed.

Generally, miniaturization of the speaker deteriorates the reproduction capability in a bass range particularly.

### SUMMARY OF THE INVENTION

An object of this invention intends to provide a speaker system with an improved bass range characteristic.

In order to attain this object, in accordance with this invention, there is provided a speaker system comprising:

a speaker,

amplitude detecting means for detecting an amplitude value of a diaphragm of the speaker to produce an amplitude signal corresponding to the amplitude value, and

adding means for adding the amplitude signal to a driving signal for driving the speaker.

Preferably, the amplitude detecting means comprises:

velocity detecting means for detecting a velocity of the diaphragm of the speaker to produce a velocity signal; and

integrating means for integrating the detected velocity signal to produce the amplitude signal.

Preferably, the integrating means is a first order low pass filter having a cutoff frequency that is lower than a lowest resonance frequency f₀ of the speaker.

In accordance with this invention, the amplitude value of the diaphragm of the speaker is detected and the amplitude value is positively fed back to the input signal. This configuration provides a meritorious effect that the bass range characteristic of the speaker is improved.

Further, in accordance with this invention, the velocity of the diaphragm of the speaker is detected, the velocity is integrated by a low pass filter having a cutoff frequency lower than the lowest resonance frequency of the speaker to detect the amplitude value, and the amplitude value is positively fed back. This configuration provides meritorious effect that the bass range of the speaker is extended and the shoulder characteristic in the bass range is made abrupt.

The above and other objects and features of the invention will be more apparent from the following description taken in conjunction with the accompanying drawings.

### BRIEF DESCRIPTION OF THE DRAWINGS

FIG. 1 is a block diagram of a speaker system according to an embodiment of this invention;

FIG. 2 is a view showing the structure of a current sensor in the embodiment of the invention;

FIG. 3 is a graph showing a sound pressure characteristic in the embodiment of the invention; and

FIG. 4 is a view for explaining the principle of this invention.

### DESCRIPTION OF THE PREFERRED EMBODIMENTS

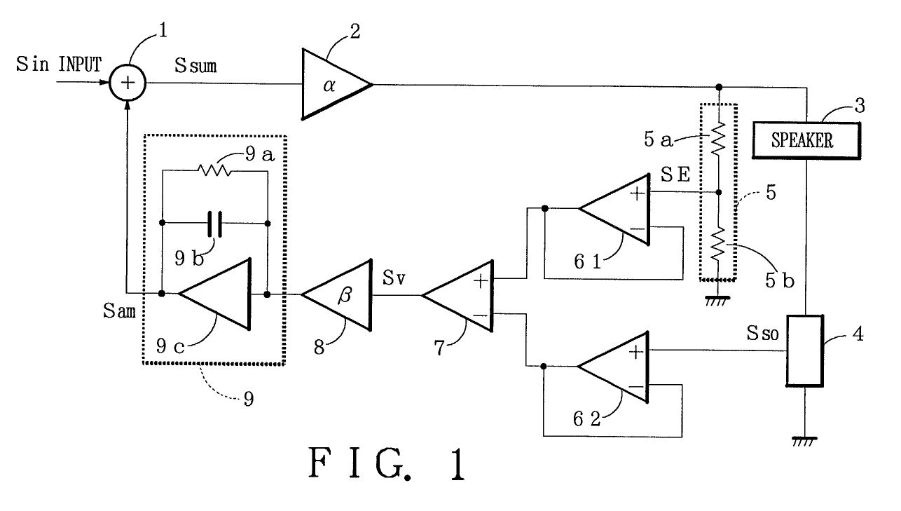

Referring to FIGS. 1 to 3, an explanation will be given of an embodiment of this invention.

FIG. 1 is a block diagram showing the configuration of a speaker system according to this invention.

The speaker system shown in FIG. 1 includes an adder 1, an amplifier 2, a hermetically-sealed speaker 3, a current sensor 4, a voltage detecting unit 5, an arithmetic unit 7, an amplifier 8 and a low pass filter 9.

The adder 1 adds an input signal Sin to the speaker system and an output signal Sam from the low pass filter 9 which serves as an integrating means described later. The amplifier 2 amplifies a sum signal outputted from the adder 1 at a prescribed amplification factor α. The speaker 3 electroacoustically transduces the sum signal Ssum thus amplified into an acoustic signal. The current sensor 4 detects a current flowing through the speaker to produce the corresponding voltage signal Sso. The voltage detecting unit 5 detects the voltage at an input terminal of the speaker 3 to produce an applying voltage signal SE proportional thereto. The arithmetic unit 7 performs a differential operation of the applying voltage signal SE supplied through a buffer amplifier 61 and another applying voltage signal Sso supplied through a buffer amplifier 62 to extract a velocity component of a diaphragm of the speaker 3, thereby producing the corresponding velocity signal Sv. The amplifier 8 amplifies the velocity signal Sv at a prescribed amplification factor β. The low pass filter 9 integrates the velocity signal Sv supplied through the amplifier 8 to produce the corresponding amplitude signal Sam.

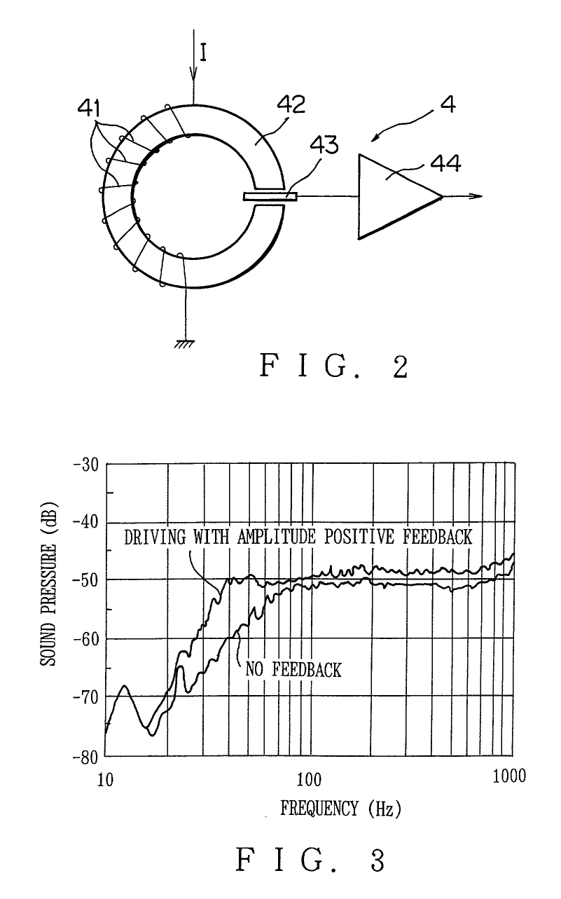

The current sensor 4, as seen from FIG. 2, includes a gap-equipped iron core 42 with an electric wire 41 wound, an Hall element 43 which is inserted in the gap of the iron core 42 and an amplifier 44 which amplifies a voltage signal produced from the Hall element 43 at a prescribed amplification factor. In such a configuration, a magnetic flux is generated in proportion to the current I flowing through the electric wire 41. The magnetic flux is converged by the iron core 42 to penetrate through the Hall element 43, thereby producing a Hall voltage due to the Hall effect. In other words, since the current I flowing through the electric wire 41 is a driving current I supplied to the speaker 3, this driving current I is converted into a voltage Sso to be produced.

The voltage detecting unit 5 is a series circuit composed of a resistors 5a and 5b which are connected in parallel to the speaker 3. The voltage value proportional to the voltage supplied to the input terminal a of the speaker 3 is detected in terms of the voltage generated across the resistor 5b. The resistance ratio of the resistors 5a and 5b is determined as necessary on the basis of the sensitivity of the current sensor 4 (sensitivity of the current/voltage conversion).

The low pass filter 9 is a parallel circuit composed of a resistor 9a, a capacitor 9b and an amplifier 9c. The low pass filter 9 serves as an integrator (i.e. having a linear gradient (−6 dB/Oct)as a frequency characteristic) for the higher frequency component than that of the cutoff frequency based on a time constant of the velocity signal Sv supplied through the amplifier 8 (the time constant is defined by the resistor and capacitor 9b). The low pass filter 9 supplies the velocity signal Sv having such a frequency component as an amplitude signal Sam to the adder 1.

Incidentally, the current sensor 4, voltage detecting unit 5, buffer amplifiers 61, 62, arithmetic unit 7 and amplifier 8 constitute a velocity detecting means. This velocity detecting means and the low pass filter 9 constitute an amplitude detecting means.

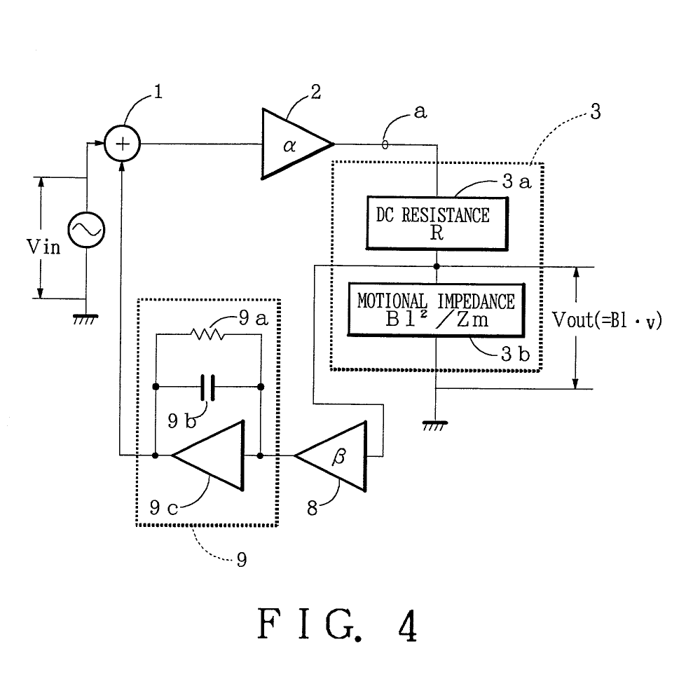

Prior to explaining the operation of the speaker system shown in FIG. 1, referring to FIG. 4, an explanation will be given of the technical concept of this invention.

This invention intends to detect the velocity of the diaphragm of a speaker, integrates the detected velocity to extract the amplitude component, and positively feeds back this amplitude component, thereby improving the bass range characteristic in the speaker system.

FIG. 4 is a block diagram for explaining the principle of this invention. In FIG. 4, the adder 1, amplifiers 2 and 8 and low pass filter 9 are those shown in FIG. 1.

The speaker 3 is represented as an equivalent circuit when it operates. Namely, the speaker 3 is a series circuit composed of a DC resistor 3a and a motional impedance 3b of a voice coil. The motional impedance 3b is an impedance which is generated owing to the vibration in a vibrating system. The voltage Vout across the impedance is proportional to the velocity v of the vibrating system, and is expressed by

Vout=B1·v

Now referring to FIG. 4, the technical concept of this invention will be explained in analytical comparison between the cases there is no amplitude positive feedback and there is amplitude positive feedback.

First, the operation of the system where there is no amplitude positive feedback (feedback path composed of the amplifier 8, low pass filter 9 and adder 1) can be expressed by

$$Vout = \frac{α \cdot Vin}{( Rvc + \frac{{Bl}^{2}}{Zm} )} \cdot \frac{{Bl}^{2}}{Zm} \qquad ( 1 )$$

where

α: gain of the amplifier 2

Zm: mechanical impedance of the speaker

(=Rm+jωLm+1/jωCm)

Rm: equivalent resistance of the vibrating system

Lm: equivalent mass of the vibrating system

Cm: equivalent compliance of the vibrating system

Rvc: DC resistance of the speaker voice coil

B1: force coefficient of the speaker unit.

The transmission G₀ of this system can be acquired from Equation (1)

$${G}_{0} = \frac{Vout}{Vin} = \frac{α}{( Rvc + \frac{{Bl}^{2}}{Zm} )} \cdot \frac{{Bl}^{2}}{Zm} = \frac{α \cdot {Bl}^{2}}{Zm \cdot Rvc + {Bl}^{2}} \qquad ( 2 )$$

$$\text{Now assuming that}$$

$$ω = 2 πf$$

$${f}_{0} = \frac{1}{2 π} \sqrt{\frac{1}{Lm \cdot Cm}}$$

$$\text{(lowest resonance frequency of the speaker system)}$$

$${Q}_{0} = \frac{2 πf 0 \cdot Lm \cdot Rvc}{{Bl}^{2}}$$

$$\text{(sharpness of the unit resonance)}$$

and assuming that the above value of Rm is negligibly small, Equation (2) is transformed into

$$\begin{matrix}{G}_{0} = \frac{α \cdot {Bl}^{2}}{Rvc \cdot ( jωLm + \frac{1}{jωCm} ) + {Bl}^{2}} \\ = \frac{α}{j \cdot \frac{\sqrt{\frac{1}{Lm \cdot Cm}} Lm \cdot Rvc}{{Bl}^{2}} \cdot ( \frac{ω}{\sqrt{\frac{1}{Lm \cdot Cm}}} - \frac{\sqrt{\frac{1}{Lm \cdot Cm}}}{ω} ) + 1} \\ = \frac{α}{j \cdot {Q}_{0} \cdot ( \frac{f}{{f}_{0}} - \frac{{f}_{0}}{f} ) + 1}\end{matrix} \qquad ( 3 )$$

Therefore, the velocity v of the diaphragm can be expressed using the equation Vout=B1·v

$$ν = \frac{{G}_{0} \cdot Vin}{Bl} = \frac{Vin \cdot α}{Bl} - \frac{1}{j \cdot {Q}_{0} \cdot ( \frac{f}{{f}_{0}} - \frac{{f}_{0}}{f} ) + 1} \qquad ( 4 )$$

Next, an explanation will be given of the operation of the system where there is an arrangement of the amplitude positive feedback.

The transmission function of the low pass filter 9 as shown in FIG. 4 is expressed by 1/(1+jωT) (T: time constant).

The operation of the system shown in FIG. 4 can be expressed by

$$α \cdot ( Vin + \frac{β}{jωT + 1} \cdot Vout ) = ( Rvc + \frac{{Bl}^{2}}{Zm} ) \cdot I = ( Rvc + \frac{{Bl}^{2}}{Zm} ) \cdot Vout \cdot \frac{Zm}{{Bl}^{2}}$$

where β is an amplification factor of the amplifier 8.

Thus, the transmission function G of the system shown in FIG. 4 can be expressed by

$$G = \frac{Vout}{Vin} = \frac{α}{\frac{Rvc \cdot Zm}{{Bl}^{2}} - \frac{α \cdot β}{jωT + 1} + 1} \qquad ( 5 )$$

Now, as in the case with no feedback, assuming that

$$ω = 2 π f$$

$${f}_{0} = \frac{1}{2 π} \sqrt{\frac{1}{Lm \cdot Cm}}$$

$${Q}_{0} = \frac{2 πf 0 \cdot Lm \cdot Rvc}{{Bl}^{2}}$$

Equation (5) can be transformed into

$$\begin{matrix}G = \frac{α}{j \cdot {Q}_{0} \cdot ( \frac{f}{{f}_{0}} - \frac{{f}_{0}}{f} ) - \frac{1}{( jωT + 1 )} \cdot α \cdot β + 1} \\ = \frac{α \cdot \frac{1}{( 1 - D )}}{1 + j \cdot {Q}_{0} \cdot \frac{1}{( 1 - D )} \cdot \{ \frac{f}{{f}_{0}} \cdot ( 1 + D \cdot \frac{T \cdot {Bl}^{2}}{Lm \cdot Rvc} ) - \frac{{f}_{0}}{f} \}}\end{matrix} \qquad ( 6 )$$

where

$$D = \frac{α \cdot β}{1 + {( ωT )}^{2}}$$

Thus, the velocity v of the diaphragm can be expressed by

$$ν = \frac{G \cdot Vin}{Bl} = \frac{Vin \cdot {α}_{MFB}}{Bl} \cdot \frac{1}{1 + j \cdot {Q}_{0 MFB} \cdot \{ \frac{f}{{f}_{0 MFB}} - \frac{{f}_{0 MFB}}{f} \}} \qquad ( 7 )$$

where

$$\begin{matrix}{α}_{MFB} = α \cdot \frac{1}{( 1 - D )} & ( 8 ) \\ {Q}_{0 MFB} = {Q}_{0} \cdot \frac{\sqrt{1 + D \cdot \frac{T \cdot {Bl}^{2}}{Lm \cdot Rvc}}}{( 1 - D )} & ( 9 ) \\ {f}_{0 MFB} = {f}_{0} \cdot \frac{1}{\sqrt{1 + D \cdot \frac{T \cdot {Bl}^{2}}{Lm \cdot Rvc}}} & ( 10 )\end{matrix}$$

From the analysis results described above, it can be seen that the apparent lowest resonance frequency f_{0MFB} of the speaker during the driving with amplitude positive feedback is shifted in the lower frequency range from the lowest resonance frequency f₀ during the driving with no amplitude positive feedback, and the sharpness of the resonance Q_{0MFB} is larger than the sharpness of the resonance Q₀ during the driving with no amplitude positive feedback. Now it should be noted that the cutoff frequency fc of the low pass filter 9 is set to be lower than the lowest resonance frequency f₀. Namely, since the low pass filter 9 operates like the integrator in a frequency range not lower than the cutoff frequency fc, the driving with amplitude positive feedback is performed in such a frequency range. Thus, by means of the operation of the low pass filter 9 having such a cutoff frequency fc, the frequency characteristic of the speaker system is extended to the lower frequency range and its shoulder characteristic becomes abrupt, thereby improving the low frequency range characteristic.

As understood from the above description, in an electrodynamic direct radiator, the reproduced sound pressure not higher than the lowest resonance frequency f₀ during the driving with no positive feedback is attenuated. In contrast, this invention can improve the low frequency range characteristic to the above frequency of f_{0MFB}.

In order to effect the amplitude positive feedback, oscillation must be prevented. To this end, the stabilizing condition is computed on the basis of a stabilization discriminating technique of Hurwitz from the transmission function of Equation (5). In this case, the speaker system must satisfy the condition of Equation (11).

$$α \cdot β < 1 + \frac{RvcRm}{{Bl}^{2}} + \frac{RvcT}{Cm \cdot {Bl}^{2}} - \frac{{Rvc}^{2} \cdot Lm \cdot T}{Cm \cdot {Bl}^{2} \cdot ( Rvc \cdot Rm \cdot T + Rvc \cdot Lm + {Bl}^{2} \cdot T )} \qquad ( 11 )$$

On the basis of the technical concept of this invention described above, an explanation will be given of the operation of the embodiment shown in FIG. 1.

In the embodiment shown in FIG. 1, in order to detect the velocity of the diaphragm, the current I flowing through the speaker and the applying voltage SE supplied to the input terminal a of the speaker are detected. The relationship between the current I and the applying voltage SE can be acquired from a basic formulas relative to electroacoustic conversion. Specifically, assuming that the voltage supplied to the input terminal a is E,

E=Rvc·I+Vout

Since Vout=B1·v (counterelectromotive force),

v=(E−Rvc·I)/B1

Thus, in the configuration shown in FIG. 1, if the arithmetic unit 7 makes the differential operation of the voltage signal Sso which is produced from the current sensor 4 and proportional to the current I which flows through the speaker 3 and the voltage signal SE which is proportional to the voltage supplied to the input terminal a of the speaker 3, the velocity signal Sv corresponding to the velocity of the diaphragm of the speaker 3 can be detected.

The velocity signal Sv thus acquired is supplied to the low pass filter 9 through the amplifier 8. The low pass filter 9 has a linear characteristic, i.e. characteristic of the gradient of −6 dB/Oct for a frequency range not lower than the cutoff frequency so that the it serves as an integrator in such a frequency range. Therefore, the velocity signal Sv is integrated, and the integrated value is supplied to the adder 1 as an amplitude signal Sam. The amplitude signal Sam is added to the input signal Sin by the adder 1 so that a positive feedback loop of the amplitude is formed. Namely, the low pass filter 9 performs the operation equivalent to that of the integrator in the frequency range not lower than the cutoff frequency fc so that it is driven in the amplitude positive feedback. Thus, the lowest resonance frequency f_{0MFB} is shifted toward the lower frequency range than the lowest resonance frequency f₀ during the driving with no positive feedback operation. In addition, the sharpness Q_{0MFB} of resonance becomes greater than Q₀. Thus, the stiffness and mechanical resistance of the vibrating system are equivalently decreased, thereby improving the bass range characteristic.

FIG. 3 is a graph showing the sound pressure characteristic of the speaker system measured with the following parameters in the configuration for the amplitude positive feedback driving shown in FIG. 1.

T: 0.0039 (sec)

R: 6.38 (Ω)

Cm: 7.46E−4 (m/N)

Lm: 5.78 (g)

B1: 4.58 (T·m)

Amplifier gain α: 19.6

Incidentally, the amplifier gain β of the amplifier 8 was was adjusted to an optimum value while the change of the characteristic was observed.

As seen from the graph of FIG. 3, by means of the driving with the amplitude positive feedback, the reproduced band in the lower frequency range is extended and the shoulder characteristic becomes abrupt, thereby improving the low frequency range characteristic. The abrupt shoulder characteristic can suppress the power consumption of the amplifier in the range out of a necessary frequency range.

In the embodiment of this invention, a closed type speaker has been explained. However, this invention should not be limited to such a speaker, but may be applied to the speaker having a configuration with no other acoustic resonance system than the diaphragm of the speaker, such as a composite hermetic-sealed type speaker, a open back type speaker, a baffle type speaker, etc.

In the embodiment, an explanation has been given of the configuration in which the velocity of the diaphragm is detected and the amplitude value acquired from its integration is subjected to the positive feedback. However, the same effect as in this invention can be expected in another configuration in which the amplitude directly detected by a displacement sensor is subjected to positive feedback, or otherwise in a still another configuration in which the acceleration detected by an acceleration sensor is integrated twice to acquire an amplitude value and the amplitude value is subjected to positive feedback.

In the embodiment, the current sensor 4 using the Hall element was used as a current detector. However, the current detector can be also realized as e.g. a bridging circuit using a resistor.

What is claimed is:

1. A speaker system comprising:
a speaker,
amplitude detecting means for detecting an amplitude value of a diaphragm of the speaker to produce an amplitude signal corresponding to the amplitude value, and
adding means for adding the amplitude signal to a driving signal for driving the speaker.

2. A speaker system according to claim 1, wherein the amplitude detecting means comprises:
velocity detecting means for detecting a velocity of the diaphragm of the speaker to produce a velocity signal; and
integrating means for integrating the integrated velocity signal to produce the amplitude signal.

3. A speaker system according to claim 2, wherein the integrating means is a first order low pass filter having a cutoff frequency that is lower than a lowest resonance frequency f₀ of the speaker.
